(19) United States
(12) Patent Application Publication
(10) Pub. No.: US 2013/0018722 A1
(43) Pub. Date: Jan. 17, 2013

(54) SYSTEM AND METHOD FOR GENERATING A KEYWORD BID

(71) Applicant: Bradd Elden Libby, Sarpsborg (NO)

(72) Inventor: Bradd Elden Libby, Sarpsborg (NO)

(21) Appl. No.: 13/181,603

(22) Filed: Jul. 13, 2011

(51) Int. Cl. G06Q 30/02

(52) U.S. Cl. 705/14.46

(57) ABSTRACT

A method for generating at least one keyword bid is provided. The method comprises accessing, over a computer network, marketing keyword data including bid data, advertising spend data, and revenue data, estimating a first relationship between the revenue data and the bid data, estimating a second relationship between the advertising spend data and the bid data, and generating at least one keyword bid based at least in part on the first relationship and the second relationship.

### FIELD OF THE INVENTION

The present invention is directed to online advertising.

### DISCUSSION OF RELATED ART

In addition to so-called “natural” search results, many search engines, such as those offered by GOOGLE, Inc. (Mountain View, Calif.) and the Microsoft Corporation (Redmond, Wash.), among others, present users with “sponsored” (i.e., paid) search results in response to a keyword search. Typically, these search engines conduct keyword auctions in which an online marketer may bid a certain amount to associate its advertisement with one or more keywords. These auctions are continuously conducted, and a marketer can adjust its bid amounts as often as desired.

When a search on one of the bid-upon keywords is performed, the marketer's advertisements may be displayed alongside other advertisements associated with the keyword. The relative position and prominence of the advertisements may be dictated to some degree by the amount of the marketer's bid and/or the quality of the advertisement; a higher bid for an advertisement with a higher quality score may command a more prominent position.

The marketer may pay the full bid amount each time the advertisement is displayed, or it may pay some other amount. For example, the Google search engine employs a variant of the next-price or “Vickrey” sealed-bid auction model. In this scenario, the marketer who places the highest bid (taking into account the quality of the associated advertisement) wins the auction, and pays the next-highest bid amount plus some defined increment (e.g., $0.01) to have its advertisement displayed in the most desirable position relative to the search results. Likewise, the second-highest bidder pays the defined increment over the third-highest bid amount to have its advertisement displayed in the second-most desirable position, and so on.

Proponents of the next-highest-bidder approach claim that it encourages marketers to bid an amount equal to what the advertisement is worth to them. In reality, marketers must determine what amount over their target advertising cost they must bid in order to pay a next-highest amount equal to their target cost.

To determine how much to bid in these second-price auctions, the marketer must first identify the average amount per event (e.g., impression or click) it is willing to pay over time for the advertisement. However, the marketer then must consider how much, if any, it should add to its bid to ensure that it pays, on average, that target amount per event over time. For example, a marketer may have determined that it would be optimal to pay $1.50, on average, for each time a search engine user clicks on the advertisement. However, bidding $1.50 would always result in the marketer paying less than $1.50 per click, since the winning marketer would always pay the next-place bid. The following table illustrates this principle, in which a hypothetical bidder A wins several auctions having a defined increment of $0.01:

| A's Bid Amount | Next Place Bid | Amount Paid Per Click |
|---|---|---|
| $1.50 | $0.94 | $0.95 |
| $1.50 | $1.44 | $1.45 |
| $1.50 | $1.29 | $1.30 |
| $1.50 | $1.09 | $1.10 |

| | |
|---|---|
| Average amount paid per click by A: | $1.20 |

The marketer may determine that it must add, for example, $0.75 to its target amount in order to actually pay the target amount on average over time. The following table illustrates this approach, where the desired average amount paid is still $1.50:

| A's Bid Amount | Second Place Bid | Amount Paid |
|---|---|---|
| $2.25 ($1.50 + 0.75) | $2.19 | $2.20 |
| $2.25 ($1.50 + 0.75) | $1.19 | $1.20 |
| $2.25 ($1.50 + 0.75) | $0.94 | $0.95 |
| $2.25 ($1.50 + 0.75) | $1.64 | $1.65 |

| | |
|---|---|
| Average amount paid per click by A: | $1.50 |

One drawback of this approach is that it requires trial and error to determine the amount that must be added to the bid (in the above example, $0.75). Furthermore, the ongoing nature of the auctions means that metrics associated with the keywords and associated advertisements are constantly in flux; time- and budget-consuming experimentation will therefore be necessary to determine or approximate the added amount required to arrive at a given desired average amount paid. In addition, the added-amount approach greatly complicates efforts to adjust individual keyword bids to affect a group of keyword bids in a predictable way.

Further complicating the task of selecting keyword bids are the facts that different marketers may have different goals, or may have differing data available to them. One marketer, due to a lack of reliable conversion tracking data, may desire bids that will maximize clicks; another with a robust tracking system in place may prefer to maximize conversions. However, marketers concerned with brand awareness may prefer to maximize impressions instead. In some cases, a marketer may have a budget that they cannot exceed; in others, a marketer may be able to act as if they have, in effect, an unlimited budget. Marketers may be subject to a rate of return, or a cost of acquisition, imposed by their organization. A marketer may or may not be able to place an exact value on a conversion, and may or may not be able to track profit and margin on a per-click basis. All of these factors make selecting optimal keyword bid amounts a challenging endeavor.

### SUMMARY OF THE INVENTION

In light of the shortcomings inherent in the approach discussed above, there is a need to generate bids without the need for the trial-and-error overbidding process described above. By identifying a relationship between the bid amount and a performance metric of interest, a bid amount corresponding to an optimal value for the performance metric can be identified without undue experimentation. In other words, marketers may wish to optimize keyword bids or bid sets for one or more keywords by identifying a relationship between bid amount and one or more performance metrics associated with the bid-upon advertisement. Such performance metrics may include, for example, the profit earned from the advertisement; the cost per action (CPA) associated with the advertisement, the revenue, the advertising cost, and the cost-of-goods-sold associated with the advertisement; the return on investment (ROI) (defined as the ratio of the profit to the total cost of the conversion); the return on ad spend (defined as the ratio of the profit to the ad cost); or the target value that the marketer wishes to spend to earn a conversion. To calculate these bid-performance relationships, it may be useful to access current, predicted, or historical performance data for a given keyword at a number of bid amounts, and determining or deriving a performance metric from the performance data. The performance data may include, for example, bid data, click data, advertising spend data, return-on-ad-spend (ROAS) data, cost-of-goods-sold data, conversion data, and impression data, among others. The bid-performance relationships may be determined by expressing certain performance metrics as a function of bid amount. The relationships may be determined through such techniques as regression or other curve-fitting, mathematical, or data-processing techniques known in the art. When the relationships between bid amount and performance have been identified in this manner from a set of performance data, it may be possible to identify a specific bid amount at which a given performance metric is at its optimal level.

For example, it may be possible or desirable to identify a bid amount that will maximize the profit generated by a keyword advertisement. It may also be possible or desirable to identify the maximum bid amount that will cause the marketer not to lose money on the advertisement—in other words, the maximum bid amount at which zero profit is earned (i.e., the bid amount at which the revenue associated with a conversion is equal to the costs incurred to generate the conversion). This bidding strategy may be desirable in situations where, for example, the marketer wishes to sacrifice profit in order to maximize the advertisement's number of impressions with the hopes of increasing the visibility of the advertised goods or services without regard to making a positive profit. In other embodiments, it may be possible to identify a bid amount that corresponds to an acceptable loss (i.e., a negative profit). In this situation, the marketer's willingness to pay a higher amount for the advertisement than the revenue that will be generated by the advertisement may ensure prominent placement of the advertisement. This may be desirable where the marketer wishes to increase impressions, clicks, or another metric. In still other situations, it may be desirable to identify a bid yielding maximum profit, but nonetheless bid an incrementally higher amount. This may have the effect of forcing higher-bidding competitors to pay a higher price, thereby reducing the profitability of the competitors' advertisements and possibly exhausting their advertising budget. As a marketer's goals change over time, she may wish to utilize a number of these approaches in succession or simultaneously. In still other embodiments, it may be possible to identify a bid amount that corresponds to a maximum number of conversions, clicks, or impressions.

Keywords and the actual or intended bid amounts associated with them may be organized into bid sets (also referred to herein as “keyword bid sets”). Use of the term “bid set” herein contemplates a set including any number of keywords, including a single keyword. Bid sets may conceptually be organized around a shared characteristic or theme, for example, a common association with a particular marketer, account, campaign, service, or product.

Furthermore, keyword bids and keyword bid sets as discussed herein include potential, hypothetical, or prospective bids or bid sets, and are not limited to those bids or bid sets actually placed. For example, a marketer may generate a bid or bid set to assess it in order to compare it to other actual or hypothetical bids or bid sets.

A performance metric may be generated or predicted for a keyword at a given bid amount, and may quantify a measured or predicted performance of at least one keyword advertisement. The performance metric may be derived from performance data accessed over a computer system. In some embodiments, the performance data may comprise one or more performance metrics. In some embodiments, a group performance metric may be generated or predicted for all or part of a bid set.

It may be possible to estimate a group performance metric that can be used to estimate the future performance of the keywords in the bid set. The group performance metric may indicate or approximate, for example, how much will be spent on the keyword during a particular time; how many impressions, clicks, or conversions the associated advertisement will gain; or the profit or ROI yielded by the advertisement. Individual keyword bids may be adjusted responsive to the predicted group performance metric in order to adjust the predicted group performance metric according to bidding rules, business goals, or the marketer's desires. For example, if it is predicted that the amount spent on the advertisement will exceed the budget for that advertisement, then individual keyword bids may be adjusted to reduce the predicted cost. Various techniques for adjusting individual keyword bids to optimize a bidding group may be used. For example, techniques that apply portfolio theory and stochastic optimization to adjust a bid set may be used.

According to one aspect of the present invention, a method for generating at least one keyword bid is provided. The method comprises accessing, over a computer network, marketing keyword data including bid data, advertising spend data, and revenue data, estimating a first relationship between the revenue data and the bid data, estimating a second relationship between the advertising spend data and the bid data, and generating at least one keyword bid based at least in part on the first relationship and the second relationship. According to one embodiment of the present invention, the act of accessing, over a computer network, marketing keyword data further comprises an act of accessing cost-of-goods-sold data, further comprising an act of estimating a third relationship between the cost-of-goods-sold data and the bid data, wherein the act of generating at least one keyword bid based at least in part on the first relationship and the second relationship comprises an act of generating at least one keyword bid based at least in part on the first relationship, the second relationship, and the third relationship. According to another embodiment of the invention, the act of generating at least one keyword bid based at least in part on the first relationship, the second relationship, and the third relationship further comprises an act of identifying a keyword bid yielding a maximal profit. According to another embodiment of the invention, the act of generating at least one keyword bid based at least in part on the first relationship, the second relationship, and the third relationship comprises an act of identifying a keyword bid yielding a less-than-maximal profit. According to another embodiment of the invention, the act of generating at least one keyword bid based at least in part on the first relationship, the second relationship, and the third relationship further comprises an act of identifying a keyword bid yielding a profit substantially equal to zero. According to another embodiment of the invention, the act of generating at least one keyword bid based at least in part on the first relationship, the second relationship, and the third relationship further comprises an act of identifying a keyword bid yielding an allowably negative profit.

According to one embodiment of the present invention, the act of generating at least one keyword bid based at least in part on the first relationship, the second relationship, and the third relationship further comprises an act of identifying a keyword bid yielding a maximum number of clicks. According to another embodiment of the invention, the act of accessing, over a computer network, marketing keyword data includes accessing an impression count. According to another embodiment of the invention, the act of generating at least one keyword bid based at least in part on the first relationship, the second relationship, and the third relationship further comprises an act of identifying a keyword bid yielding a maximum number of impressions. According to another embodiment of the invention, the act of accessing, over a computer network, marketing keyword data further comprises an act of accessing budget limit data representing an advertising budget. According to another embodiment of the invention, the act of generating at least one keyword bid based at least in part on the first relationship, the second relationship, and the third relationship includes comparing the budget limit data to the advertising spend data. According to another embodiment of the invention, the act of generating at least one keyword bid based at least in part on the first relationship, the second relationship, and the third relationship further comprises an act of identifying a keyword bid having a highest profit. According to another embodiment of the invention, the method further comprises an act of allocating a portion of a budget to the specific keyword bid.

According to one embodiment of the present invention, the method further comprises an act of iteratively allocating portions of a budget to each of the at least one keyword bid in descending order of marginal profit. According to another embodiment of the invention, the method further comprises an act of ceasing allocating portions of the budget when the entire budget is allocated. According to another embodiment of the invention, the act of generating at least one keyword bid based at least in part on the first relationship and the second relationship further comprises an act of identifying a keyword bid yielding a maximal return on advertising spend. According to another embodiment of the invention, the act of generating at least one keyword bid based at least in part on the first relationship and the second relationship further comprises an act of identifying a keyword bid yielding a return on advertising spend substantially equal to zero. According to another embodiment of the invention, the act of generating at least one keyword bid based at least in part on the first relationship and the second relationship further comprises an act of identifying a keyword bid yielding an allowably negative return on advertising spend. According to another embodiment of the invention, the act of accessing, over a computer network, marketing keyword data further comprises an act of accessing budget limit data representing an advertising budget. According to another embodiment of the invention, the act of generating at least one keyword bid based at least in part on the first relationship and the second relationship further comprises an act of identifying a keyword bid having a highest return on advertising spend.

According to one embodiment of the present invention, the method further comprises an act of allocating a portion of the advertising budget to the at least one keyword bid having the highest return on advertising spend. According to another embodiment of the invention, the method further comprises an act of iteratively allocating portions of the advertising budget to each of the at least one keyword bids in descending order of marginal return on advertising spend. According to another embodiment of the invention, the method further comprises an act of ceasing allocating portions of the advertising budget when the entire budget is allocated. According to another embodiment of the invention, the method further comprises an act of transmitting the at least one keyword bid to an advertising network via the computer network.

According to one aspect of the present invention, a method for generating at least one keyword bid is provided. The method comprises accessing, over a computer network, marketing keyword data including at least bid data, advertising spend data, and conversion data, estimating a first relationship between the advertising spend data and the bid data, estimating a second relationship between the conversion data and the bid data, and generating at least one keyword bid based at least in part on the first relationship and the second relationship. According to one embodiment of the present invention, the act of accessing, over a computer network, marketing keyword data further comprises an act of accessing a target value per conversion. According to another embodiment of the invention, the act of generating at least one keyword bid based at least in part on the first relationship and the second relationship further comprises an act of identifying a keyword bid yielding a maximal number of conversions based at least in part on the target value per conversion. According to another embodiment of the invention, the act of generating at least one keyword bid based at least in part on the first relationship and the second relationship further comprises an act of identifying a keyword bid yielding a maximal number of clicks based at least in part on the target value per conversion. According to another embodiment of the invention, the act of accessing, over a computer network, marketing keyword data further comprises an act of accessing impression data.

According to one embodiment of the present invention, the act of generating at least one keyword bid based at least in part on the first relationship and the second relationship further comprises an act of identifying a keyword bid yielding a maximal number of impressions, based at least in part on the target value per conversion and the impression data. According to another embodiment of the invention, the act of accessing, over a computer network, marketing keyword data further comprises an act of accessing budget limit data. According to another embodiment of the invention, the act of generating at least one keyword bid based at least in part on the first relationship and the second relationship further comprises an act of identifying a keyword bid yielding a maximal number of conversions, based at least in part on the budget limit data. According to another embodiment of the invention, the act of generating at least one keyword bid based at least in part on the first relationship and the second relationship further comprises an act of identifying a keyword bid yielding a maximal number of clicks, based at least in part on the budget limit data. According to another embodiment of the invention, the act of accessing, over a computer network, marketing keyword data further comprises an act of accessing impression data. According to another embodiment of the invention, the act of generating at least one keyword bid based at least in part on the first relationship and the second relationship further comprises an act of identifying a keyword bid yielding a maximal number of impressions, based at least in part on the budget limit data and the impression data.

According to one embodiment of the present invention, the method further comprises an act of identifying a keyword bid with the lowest marginal cost per conversion. According to another embodiment of the invention, the method further comprises an act of allocating a portion of the advertising budget to the specific keyword bid. According to another embodiment of the invention, the method further comprises an act of iteratively allocating portions of the advertising budget to each of the at least one keyword bids in ascending order of marginal cost per conversion. According to another embodiment of the invention, the method further comprises an act of ceasing allocating portions of the advertising budget when the entire budget is allocated.

According to one aspect of the present invention, a method for generating at least one keyword bid is provided. The method comprises accessing, over a computer network, marketing keyword data including at least bid data, advertising spend data, and click data, estimating a first relationship between the advertising spend data and the bid data, estimating a second relationship between the click data and the bid data, and generating at least one keyword bid based at least in part on the first relationship and the second relationship.

According to one aspect of the present invention, a method for generating at least one keyword bid is provided. The method comprises accessing, over a computer network, marketing keyword data including at least bid data, advertising spend data, and impression data, estimating a first relationship between the advertising spend data and the bid data, estimating a second relationship between the impression data and the bid data, and generating at least one keyword bid based at least in part on the first relationship and the second relationship.

According to aspect of the present invention, a system comprising a memory configured to store bid data, advertising spend data, revenue data, and cost-of-goods-sold data, a relationship engine configured to estimate a first relationship between the revenue data and the bid data, a second relationship between the advertising spend data and the bid data, and a third relationship between the cost-of-goods-sold data and the bid data, and a bid generation engine configured to generate at least one keyword bid based at least in part on the first relationship, the second relationship, and the third relationship. According to one embodiment of the present invention, the bid generation engine further comprises an adjustment engine configured to adjust, responsive to the user input, at least one keyword bid, further comprising a user interface configured to receive user input. According to another embodiment of the invention, the user interface further comprises a performance axis of a cartesian graph, and wherein the system is configured to receive user input and, responsive to the user input, selectively associate the performance axis with a performance metric. According to another embodiment of the invention, the user interface further comprises a performance curve based at least in part on the first relationship, the second relationship, and the third relationship. According to another embodiment of the invention, a first portion of the performance curve corresponding to disallowed bid amounts is disabled, and wherein a second portion of the performance curve corresponding to allowed bid amounts is enabled. According to another embodiment of the invention, the system further comprises a network interface configured to allow the system to access, over a computer network, the bid data, the advertising spend data, the revenue data, and the cost-of-goods-sold data.

According to one embodiment of the present invention, the system further comprises an application programming interface configured to access the bid data, the advertising spend data, the revenue data, and the cost-of-goods-sold data on a second system. According to another embodiment of the invention, the second system comprises a database associated with a search engine.

According to one aspect of the present invention, a computer-readable medium comprising computer-executable instructions that, when executed on a processor of a server, perform a method for generating at least one keyword bid is provided. A method for generating at least one keyword bid is provided comprising accessing, over a computer network, marketing keyword data including bid data, advertising spend data, revenue data, and cost-of-goods-sold data, estimating a first relationship between the revenue data and the bid data, estimating a second relationship between the advertising spend data and the bid data, estimating a third relationship between the cost-of-goods-sold data and the bid data, and generating at least one keyword bid based at least in part on the first relationship, the second relationship, and the third relationship.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example computer system upon which various aspects of the present embodiments may be implemented;

FIG. 2 shows an example system for generating at least one keyword bid in accordance with an embodiment;

FIG. 3 depicts a block diagram of an application programming interface (API) in accordance with an embodiment;

FIG. 4 shows a block diagram of an exemplary user interface in accordance with an embodiment;

FIGS. 5A and 5B show example processes for generating at least one keyword bid in accordance with an embodiment;

FIG. 6 illustrates a calculation showing the relationship between cost data, click data, and bid data in accordance with an embodiment;

FIG. 7 depicts a generalized relationship between a keyword bid amount and the expected profit from a keyword advertisement;

FIG. 8 is an example of a user interface in accordance with an embodiment;

FIG. 9 is an example of another user interface in accordance with an embodiment; and

FIG. 10 shows the user interface of FIG. 9 with a zoom function applied.

### DETAILED DESCRIPTION

A system and method are provided for generating at least one keyword bid. The system and method provide for accessing, over a computer network, marketing keyword data including bid data, advertising spend data, and revenue data. A first relationship between the revenue data and the bid data is estimated, for example, through regression, curve fitting, or other mathematical or data-processing techniques. A second relationship between the advertising spend data and the bid data is estimated. At least one keyword bid is generated based at least in part on the first relationship, and the second relationship.

In some embodiments, cost-of-goods-sold data may also be accessed over the computer network, and a third relationship between the cost-of-goods-sold data and the bid data may be estimated. At least one keyword bid may be generated based at least in part on the first relationship, the second relationship, and the third relationship.

One or more of these features may be implemented on one or more computer systems coupled by a network (e.g., the Internet). Example systems upon which various aspects are implemented, as well as exemplary methods performed by those systems, are discussed in more detail below. Exemplary user interfaces configured for use in connection with the systems and methods are also described.

The aspects disclosed herein are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to generating at least one keyword bid. However, such a system may also perform other functions. Moreover, the systems described herein may be configured to include or exclude any of the functions discussed herein. Thus, these systems are not limited to specific functions or sets of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

### Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

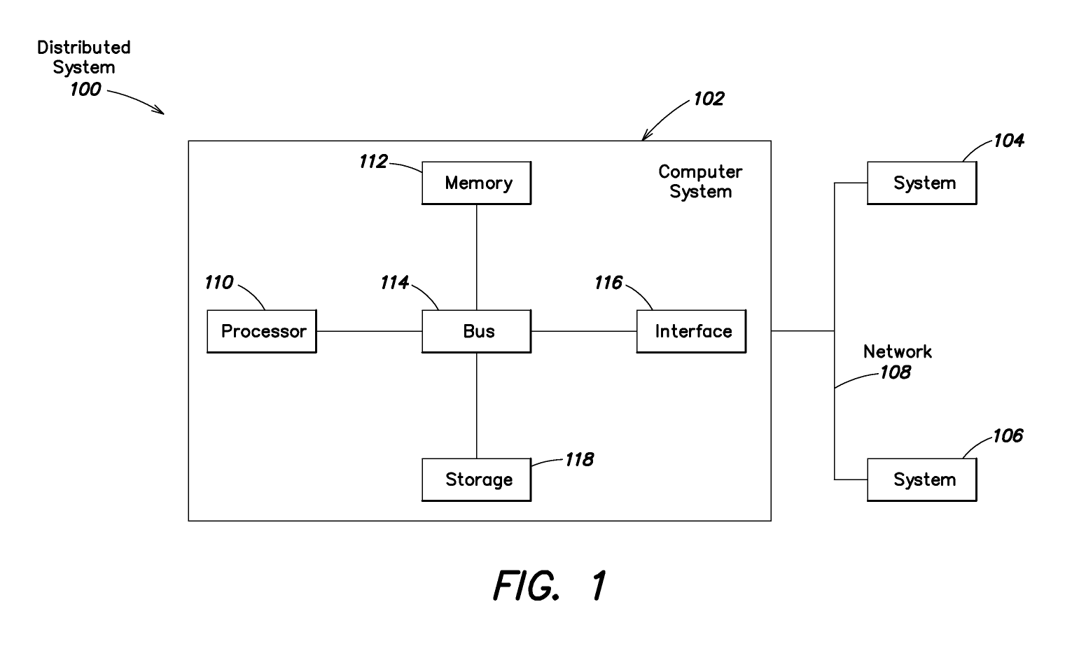

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device, such as flash memory or phase-change memory (PCM). Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

Computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

Storage system 118 may include a computer-readable and computer-writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing product, such as, for example, the Google search engine available from Google of Mountain View, Calif., the Yahoo search engine available from Yahoo! of Sunnyvale, Calif.; the Bing search engine available from Microsoft of Seattle Wash. Aspects of the system may be implemented on database management systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

In addition, the method described herein may be incorporated into other hardware and/or software products, such as a web publishing product, a web browser, or an internet marketing or search engine optimization tool.

Example System Architecture

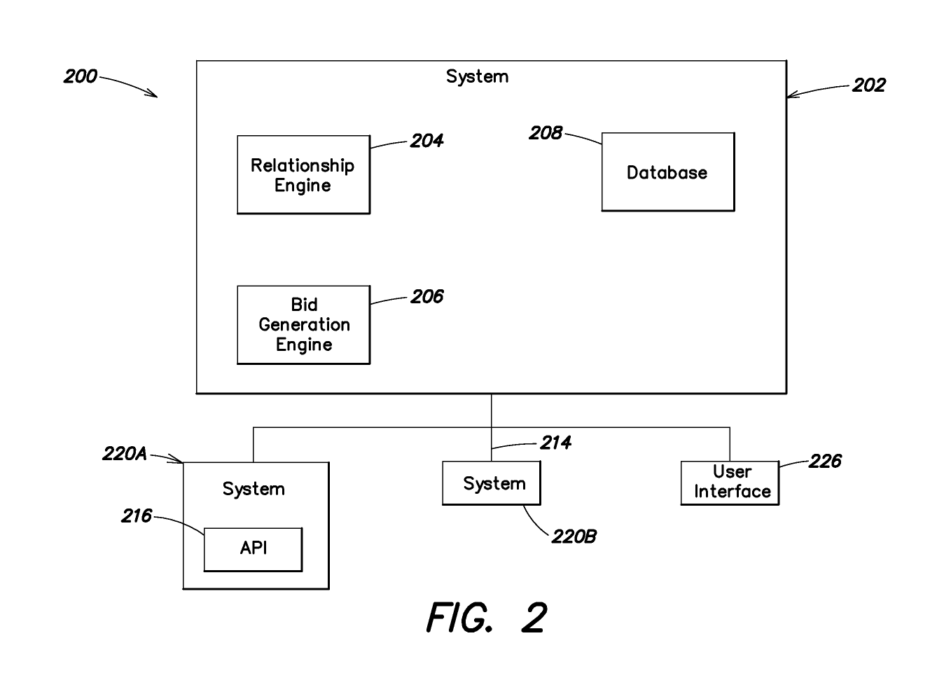

An example system in accordance with aspects of the invention can be seen in FIG. 2. The distributed system 200 may be used by or on behalf of a marketer interested in generating at least one keyword bid. As used herein, the term “marketer” may refer to either a user of the system 200, an entity on whose behalf the user is acting, or any entity associated with search engine marketing, without limitation.

The distributed system 200 includes a system 202. The system 202 may be a personal computer, a network appliance, a mainframe terminal, PDA, tablet computer, or any other computer system known in the art. The distributed system 200 includes a network interface 214 that may be configured to access keyword data over a computer network. The keyword data may include, for example, bid data, revenue data, advertising spend data, cost-of-goods-sold data, click data, conversion data, and/or impression data. The system 202 includes a relationship engine 204, which is configured to identify at least one relationship between the bid data and keyword data,revenue data, advertising spend data, cost-of-goods-sold data, click data, conversion data, and/or impression data. The system 202 also may include a database 208, which may store the marketing keyword data. The database 208 may also store one or more keywords for which information should be accessed and/or maintained. The system 202 may also include a bid generation engine 206, which may be configured to generate, based at least in part on the at least one relationship identified by the relationship engine 204, at least one keyword bid. In some embodiments, the bid generation engine 206 may also be configured to predict a group performance metric for the keyword bid set and adjust, responsive to the predicted group performance metric, at least one keyword bid in the keyword bid set. The distributed system 200 may also include a user interface 226 for allowing the user to interact with the distributed system 200 and/or system 202.

The network interface 214 may be configured to allow the system 202 to access performance data from other computer systems 220A and/or 220B over a computer network, for example, the Internet. The performance data may include bid data, click data, impression data, conversion data, revenue data, advertising spend data, and/or cost-of-goods-sold data. In some embodiments, the system 202 may be configured to access performance data stored in a format such as CSV, XML, delimited file, flat text file, or other format. In other embodiments, the network interface 214 may access performance data on the other system 220A through an Application Programming Interface (API) 216. The system 202 may be configured to store the performance data in the database 208 or in another memory location so that it may be accessed at a later time.

In some embodiments, the other system 220A may be associated with or controlled by an entity that conducts keyword auctions, such as Google, Yahoo!, Bing, and Ask.com. The other system 220A may make performance data available to be accessed through the network interface 214 for no charge, or may allow access for a per-access or subscription fee.

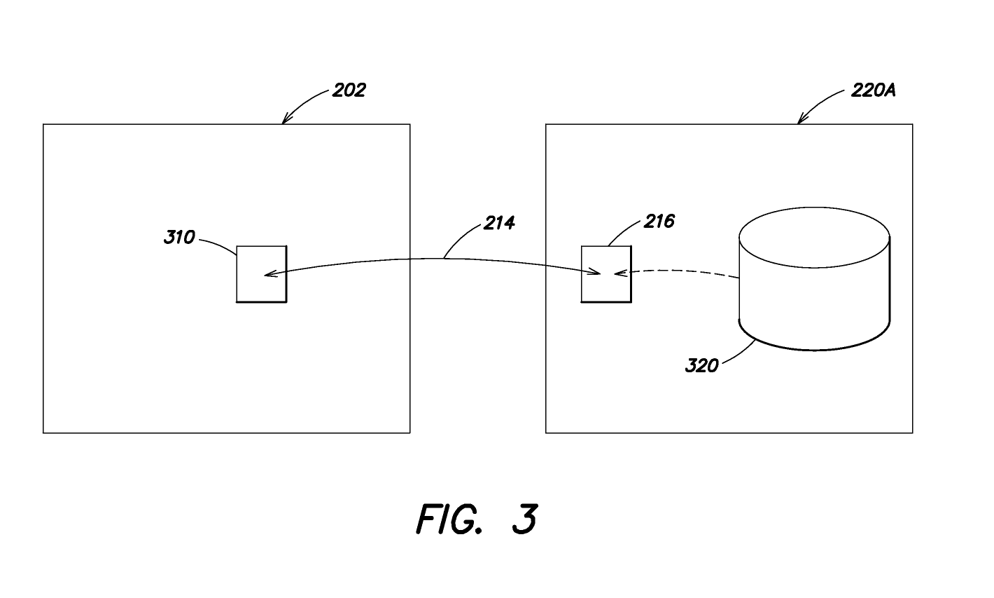

A block diagram showing an exemplary API 216 can be seen in FIG. 3. The API 216 may be an interface implemented by a software program on system 220A, thereby allowing the system 202 to interact with system 220A over the network interface 214. Software 310 that is configured to interact with the API 216 may be implemented on system 200. The API 216 and/or the software 310 may allow the system 202 to indirectly access information stored in a database 320 on the other system 220A. According to one embodiment, the API 216 may be implemented as a web service based on a protocol such as Simple Object Access Protocol (SOAP), or may be implemented on another architecture, such as a Representational State Transfer (REST) architecture. In some embodiments, the API 216 may interact with the Google AdWords API.

Referring again to FIG. 2, the relationship engine 204 may be configured to estimate or identify at least one relationship between the bid data and the performance data. For example, as explained in more detail in reference to the exemplary method described below, the relationship engine 204 may be configured to model performance data as a linear or power-law function of bid data. The relationship engine 204 may be a software component configured to perform mathematic analytic techniques, for example, regression analysis or other curve-fitting technique.

In some embodiments, where a bid corresponding to a certain profit or an optimal profit is desired, the relationship engine 204 may be configured to estimate a first relationship between revenue data and bid data. The relationship engine 204 may also be configured to estimate a second relationship between advertising spend data and bid data. The relationship engine 204 may also be configured to estimate a third relationship between cost-of-goods-sold data and bid data.

In other embodiments, where a certain or optimal value of another performance metric is desired, the relationship engine 204 may be configured to estimate a first relationship between advertising spend data and bid data, and estimate a second relationship between the other performance metric and bid data. For example, in some embodiments, the second relationship may be between conversions and bid data. In other embodiments, the second relationship may be between clicks and bid data. In still other embodiments, the second relationship may be between impressions and bid data.

The database 208 may be a relational database or any other method of storing data known in the art, such as XML, flat file, or spreadsheet, or other location in a computer memory. The database 208 may be a commercial database product, such as IBM DB2, Microsoft SQL Server, MySQL, Openbase, Sybase, or other database product. The database 208 may store textual information and/or binary information, and may store textual information as plain text, or may encode it in binary or other format.

The database 208 may be configured to store performance data, and it may also be configured to store metrics and other data derived from the performance data and bid amounts and other sources. Examples of such metrics include ROI, profit, impressions, clicks, conversions, advertising cost such as cost per click (CPC), cost of goods sold, and ROAS.

In some embodiments, the database 208 may store performance data for some defined period of time. Retaining performance data may be useful to avoid statistical inaccuracies arising from smaller sample sizes. In some embodiments, it may be possible to compare current performance data to historic performance data to identify any deviations exceeding a certain threshold. In the event that such deviations exist, the current performance data may be discounted. In other embodiments, the system 200 may generate a weighted average of current and historical performance data to compensate for any statistical limitations of a small set of current performance data. For example, in some embodiments, historical performance data may be balanced against current performance data to create a set of performance data to be used in generating bids. The historical performance data may be given a lesser weight to reflect the fact that its age may make it less useful in generating bids. For example, a weighted average of the current and historical performance data may be determined, with most recent data weighed more heavily than older data. In some embodiments, historical performance data (e.g., data from the most recent day for which performance data is available) may be used in situations where current performance data is unavailable.

In some embodiments, a weighted average may be determined, at least in part, according to the time, or day of the week, month, or year in which the performance data was recorded. For example, when calculating a bid or bid set for a particular day of the week, it may be desirable to give more weight to historical performance data from that day of the week.

In other embodiments, the database 208 may not be present; performance data may be accessed over the computer network and temporarily stored while the steps of the exemplary methods described herein are performed.

The bid generation engine 206 may be configured to generate at least one keyword bid based at least in part on the relationships identified by the relationship engine 204. A keyword bid represents an amount to be bid in an online auction for the opportunity to have one's advertisement displayed in association with a particular search engine keyword. As explained in more detail with reference to the exemplary embodiments herein, the bid generation engine 206 may determine, for at least one keyword bid, a bid amount that corresponds to a certain value or to an optimal value. For example, the bid generation engine 206 may determine a bid amount that is expected to yield the maximum possible profit, or the maximum number of clicks, conversions, or impressions.

In some embodiments, the bid generation engine 206 may also be configured to predict a group performance metric for more than one keyword bid. Predicting the group performance metric may allow the marketer to forecast what the overall or average effect of its keyword bids will be in terms of cost, effectiveness, or other measure. For example, in some embodiments, the bid generation engine 206 may be configured to predict, based at least in part on the relationships estimated by the relationship engine 204, the estimated amount that will be spent on purchasing advertising for that keyword during a given time period. As another example, the bid generation engine 206 may be configured to predict the average CPC for all keywords in a bidding set.

In some embodiments, the bid generation engine 206 may also be configured to adjust at least one keyword bid in the keyword bid set responsive to the predicted group performance metric. In some embodiments, the bid generation engine 206 may take into account budget limit data. For example, where the predicted group performance metric indicates that the cost of the keyword bid set will exceed the budget for that keyword bid set, the bid generation engine 206 may reduce the bid amount for one or more keyword bids. As explained in more detail below, this adjustment may be an iterative process until the predicted composite performance falls within an acceptable range or above or below a certain threshold.

In some embodiments, the bid generation engine 206 may be configured to identify a target group performance metric. This target group performance metric may be, for example, a maximum amount to be spent on advertising for certain keywords. In some embodiments, the target group performance metric may be derived from historical data. In other embodiments, the target group performance metric may be entered by a user of the user interface 226. In still other embodiments, the target group performance metric may be defined by a system administrator through a configuration setting, for example, in a config file.

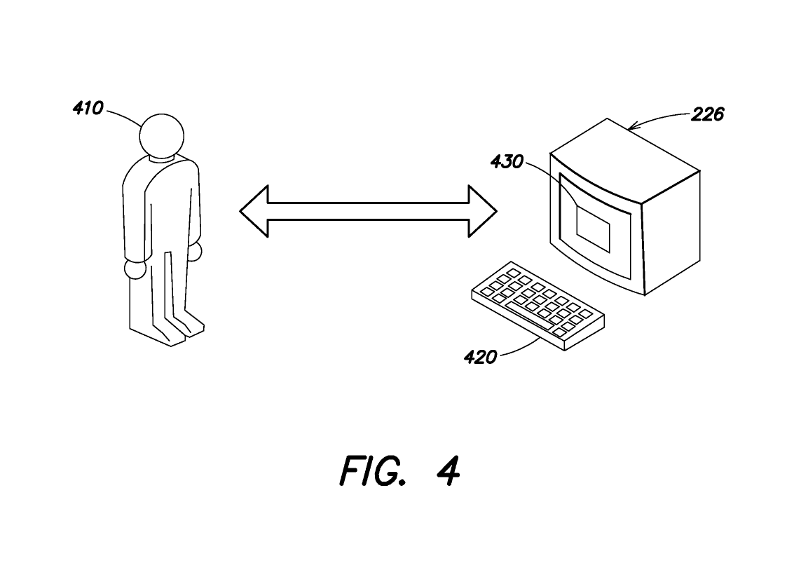

A block diagram illustrating an exemplary user interface can be seen in FIG. 4. The user interface 226 may allow a user 410 to interact with the user interface 226 through the use of a user input device 420. The user input device 420 may be of any type known in the art, such as a keyboard, mouse device, trackball, microphone, touch screen, printing device, or display screen. The user interface 226 may display an indication 430 in response to the input entered by the user 290. For example, the indication 430 may indicate whether the user input is valid.

### Exemplary Method

Having described various aspects of a system for generating keyword bid sets, the operation of such a system is now described.

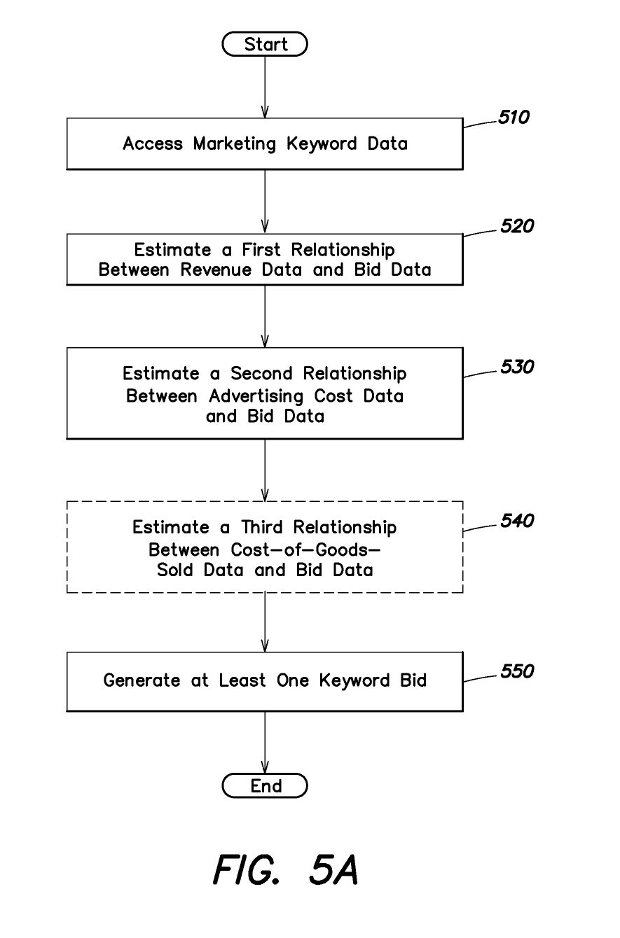

A method according to one embodiment is described with reference to FIG. 5A. In some embodiments, the method may be embodied in a module, plugin, or component of a bid management system such as the AdMax™ online marketing platform offered by the Search Agency of Santa Monica, Calif. In other embodiments, the method may be embodied in a stand-alone application that performs the functions described herein.

In act 510, performance data for a plurality of keyword bid amounts may be accessed over a computer network. In some embodiments, the performance data may be historical data, or may be estimated from or derived from historical data. For example, the performance data may include keyword-specific performance metrics for each of a number of bid amounts. This historical performance data may be specific to a particular marketer, or may be aggregated from the performance of multiple keywords for which bids were placed during a certain time period. In other embodiments, the performance data may be predicted or estimated values for metrics that have not yet been recorded or which were not recorded.

The performance data may include bid amounts as well as search marketing metrics known in the art, including impressions, clicks, conversions, profit, ROI, cost per click, ROAS, and others. An impression is an occurrence of a given advertisement being displayed to a user of a search engine. A click is an occurrence of a user of a search engine using a user interface device (e.g., a keyboard or a mouse) to click on or otherwise favorably interact with a given advertisement. CPC (cost-per-click) is the cost incurred (i.e., price paid) by a marketer when a user clicks on an advertisement associated with the marketer. In some embodiments, the cost may represent, for example, a “pay-per-click” fee incurred by the marketer and payable to the search engine every time a user clicks on an advertisement associated with the marketer. In other embodiments, a “pay-per-impression” fee model may be used; in these embodiments, the cost-per-click can be calculated by determining the number of impressions required, on average, to generate a click (i.e., impressions per click), then multiplying that by the cost per impression to arrive at the cost per click.

In some embodiments, information may be accessed about sales or other transactions relating to the product or service that is the subject of one or more advertisements associated with the plurality of keywords. Such performance data may include, for example, the revenue from the transaction, the cost of goods sold (COGS), the advertising cost, and the profit from the transaction. In some embodiments, this data may be accessed through a data source such as a sales or accounting database.

In some embodiments, an initial or approximate keyword bid amount may be determined, and performance data may be accessed for the most similar bid amounts for which performance available. For example, if it is determined that the amount to be bid for a particular keyword will be approximately $1.00, then performance data that is available for bid amounts close to $1.00 (e.g., $0.96 and $1.02) may be accessed.

In some embodiments, all available performance data for a particular bid amount may be accessed. For example, the number of clicks received at a given bid amount by each advertisement associated with a particular keyword may be accessed. In other embodiments, summarized or partially summarized performance data may be accessed. For example, for a given keyword, only a total or average number of clicks received by an advertisement associated with the keyword over a given period of time may be accessed. Any type of statistical measure known in the art may be used, including the sum, count, mean, median, mode, or other measure.

As an example of accessing performance data for a plurality of keyword bid amounts, performance data may be accessed for a given keyword for bid amounts $5.00, $4.65, $3.00, $2.75, and $2.00. The performance data may include historical performance data for keywords and/or advertisements associated with the keyword, where the performance data corresponds to each of those bid amounts. For example, the cost of the advertisement, as well as the number of impressions and clicks for all advertisements associated with keywords may be accessed for one or more recent or historic bid amounts. An example of performance data corresponding to those bid amounts could be represented as follows:

| Bid | CPC | Clicks | Impressions |
|---|---|---|---|
| $5.00 | $4.00 | 842 | 7959 |
| $4.65 | $3.95 | 754 | 7193 |
| $3.00 | $2.84 | 302 | 6487 |
| $2.75 | $2.65 | 194 | 4939 |
| $2.00 | $1.45 | 120 | 3021 |

Referring still to act 510, the performance data may be accessed over a computer network such as the Internet, and may be accessed using an Internet protocol known in the art, for example, HTTP, HTTPS, or FTP. In some embodiments, an API may be used to interact with remote data sources or databases. For example, an API may be used to access metrics relating to the Google AdWords keyword bidding program. In still other embodiments, the performance data may be accessed through the use of a scripting language such as PHP, CGI, or the like, or may be accessed through the use of a query language such as MySQL.

In some embodiments, the performance data may be automatically accessed over the computer network at regularly scheduled intervals, for example, as part of a batch download process. In other embodiments, the access of performance data may be may be triggered through a particular interaction by a user with a user interface, such as the user signaling the intent to generate a keyword bid set.

The performance data may be accessed and/or stored in any number of formats, including XML, plain text, or any of a number of database formats such as IBM DB2, Microsoft SQL Server, MySQL, Openbase, Sybase, or other database format.

In acts 520 and 530, a first relationship is estimated between the revenue data and the bid data, and a second relationship is estimated between the advertising cost data and the bid data. In optional act 540 in some embodiments, a third relationship may be estimated between the cost-of-goods-sold data and the bid data. In some embodiments, the relationships may be represented as functions, with the performance data being expressed as a function of bid data. For example, the relationship between the bid data and the revenue data, the advertising spend data, and the cost-of-goods-sold data may be expressed as one or more linear relationships, polynomial relationships, or power-law relationships.

In some embodiments, one or more types of performance data may be used to derive performance metrics. For example, the performance data may include the cost of the goods or services relating to the advertisements associated with a keyword, the cost of the advertisements themselves, as well as the revenue from sales made through those advertisements. The performance data may also include the number of clicks associated with those advertisements.

By knowing the revenue and one or more associated costs, it may be possible to determine the profit associated with the bid through application of the function profit=revenue−cost. The relationship between performance data and bid amount may be expressed according to one or more mathematical equations. In some embodiments, the relationship between performance data and bid amount may be expressed as a linear relationship. For example, where the performance metric is ROI, the relationship may be expressed as ROI=m*bid+x, where m and x are constants. In other embodiments, where the performance metrics are Clicks and CPC, the relationships may be expressed as Clicks=m*bid+x and CPC=n*bid+y, where m, n, x, and y are constants.

In other embodiments, the relationship between performance data and bid amount may be expressed as one or more power-law relationships. In some embodiments, the performance data may include, for a number of bid amounts, the cost of a given keyword advertisement and the number of clicks the keyword advertisement received during some period of time. In some embodiments, the relationship between bid data, cost data, and click data may be expressed as follows, where the performance metric CPC has been derived and A, B, α (alpha), and β (beta) are constants:

Clicks=A·bid^{α}

CPC=B·bid^{β}

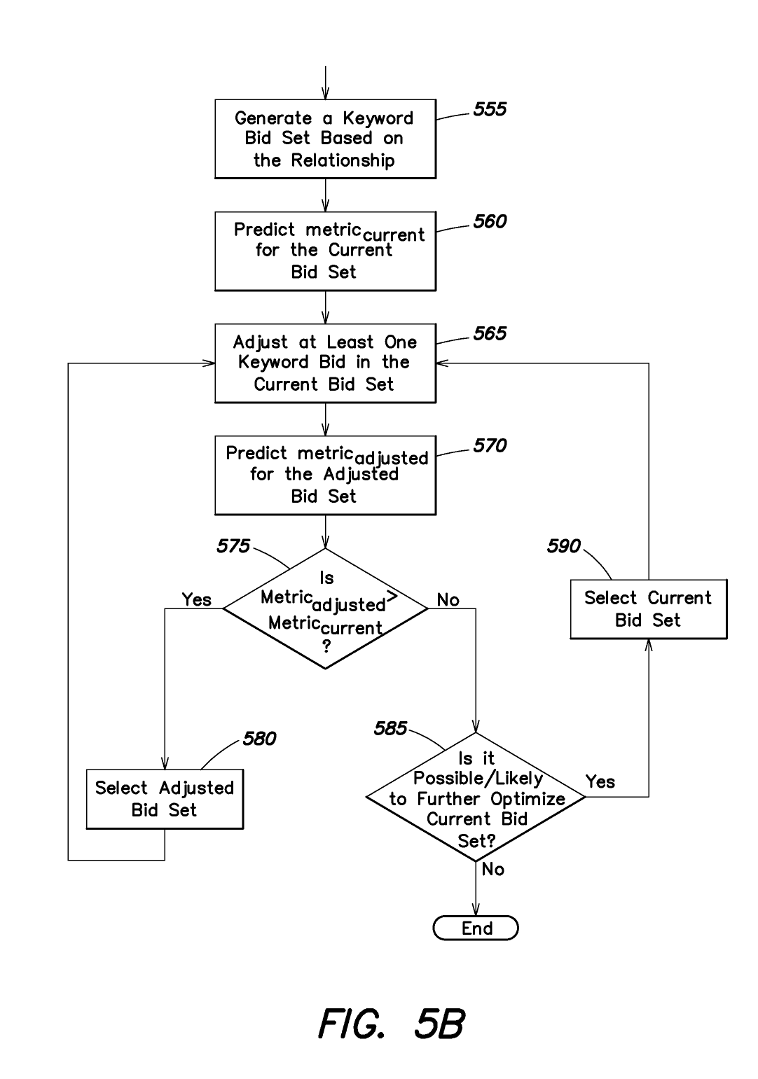

With these relationships and the definition of profit as a starting point, FIG. 6 illustrates how the profit earned from the keyword advertisement can also be expressed as a function of A, B, α, β, bid, and Value Per Click (VPC). The latter may be defined as VPC=(Revenue Per Conversion−Cost of Goods Sold Per Conversion)×Conversion Rate. Profit can therefore be expressed as follows:

Profit=VPC (A·bid^{α})−(AB·bid^{α+β})

Therefore, if constants A, B, α, β, and VPC can be calculated, then Profit can be calculated for any given bid amount, since Profit is a function of bid amount.

Referring again to the following relationships:

Clicks=A·bid^{α}

CPC=B·bid^{β}

Since the values of Clicks, CPC, and bid amount were acquired in act 510 or can be derived from performance data acquired in act 510, the values of A, B, α, and β can be determined with reference to the performance data through any of several techniques known in the art, for example, linear or non-linear regression. Similarly, VPC can be determined with reference to revenue, the cost of the goods, and the conversion rate. For example, if it is known that a conversion brings in $300 in revenue, that the goods sold cost $200, and that each click has a 5% chance of yielding a conversion (i.e., 5% conversion rate), then the VPC is ($300−200)×0.05=$5.

It will be appreciated that these equations may only accurately model the relationship over a particular range of bids, with the range being relatively narrow in some embodiments. For example, the equations may accurately model the relationship over a bidding range from $1.00 to $1.30.

In act 550, at least one keyword bid is generated based at least in part on the first relationship and the second relationship. In some embodiments, the at least one keyword bid may be generated based at least in part on the first relationship, the second relationship, and the third relationship discussed above with respect to optional act 540.

The at least one keyword bid may be generated with the goal of generating bids that maximize or minimize a particular metric, or yield a value as close as possible to a target value. For example, in some embodiments it may be possible to identify the bid amount corresponding to maximum profitability. Because the values for constants A, B, α, β, and VPC can be calculated as explained in the foregoing acts, profit can be expressed as a function of bid amount.

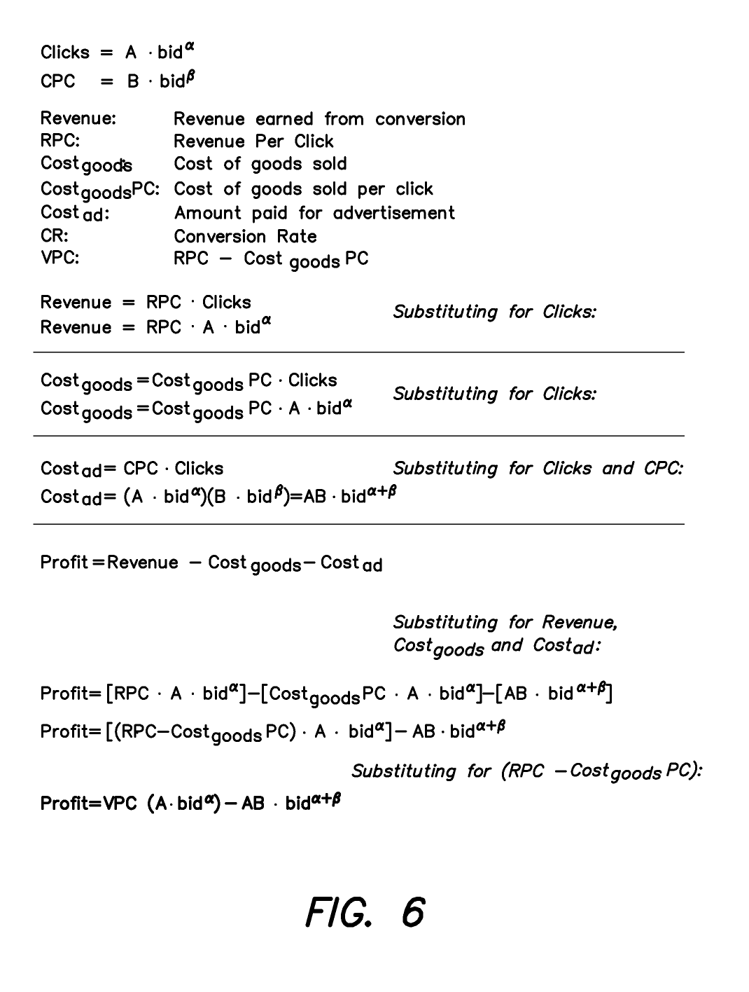

A graph 700 plotting profit vs. bid as curve 710 can be seen in FIG. 7. An optimal profit point 720 represents the point of maximum profit. Optimal profit point 720 may be located through any of a number of techniques known in the art, for example, setting the calculus derivative of the curve 710 equal to zero and solving for the bid amount at that point.

In other embodiments, it may be possible to identify the maximum bid amount that will not cause the marketer to lose money on the advertisement. Zero profit point 730 represents the maximum bid amount at which profit equals zero. This bid amount may be desirable in situations where, for example, the marketer wishes to maximize the advertisement's number of impressions to increase brand awareness without regard to making a positive profit. Since a higher bid will typically result in a higher number of impressions, bidding at zero profit point 730 yields the marketer the maximum number of impressions without losing money.

In still other embodiments, it may be desirable to identify a negative bid amount 750 that will cause the marketer to lose a certain allowable amount of money (i.e., earn a negative profit) on the advertisement. This may be desirable where the marketer wishes to increase impressions, clicks, or another metric. In this situation, the marketer's willingness to pay a higher amount for the advertisement than the revenue that will be generated by the advertisement may ensure prominent placement of the advertisement.

In other embodiments, it may be desirable to identify the optimal profit point 720 of maximum profit, but to bid incrementally higher than that amount, resulting in a profit corresponding to super-optimal profit point 740. This approach may be desirable where the marketer wishes to increase the advertising costs of its competitors. For example, at optimal profit point 720, the marketer bids $4.60, and the profit earned by the marketer is $317.50. Bidding $4.60 will cause the next-highest bidder to pay $4.60 per click its advertising yields (prior to any quality score adjustments or other adjustments). If the marketer increases its bid to slightly over $5.00, corresponding to super-optimal point 740, the marketer will still earn a profit of around $300. Thus, its profit has dropped by roughly 5%. However, the next highest bidder must now pay $5.00 per click instead of $4.60, meaning its CPC has increased by about 9%. Thus, the marketer has increased its profitability relative to its competitor.

FIG. 5B illustrates an embodiment of a similar method with additional functionality. In some embodiments, some or all of acts 510, 520, 530, 540 and/or 550 in FIG. 5A may be performed. In act 555, a keyword bid set is generated, and in act 560, a group performance metric for a current keyword bid set comprising a plurality of keyword bids may be predicted. This predicted group performance metric may be a measurement or characteristic of the keywords bids or the keywords themselves. In some embodiments, the group performance metric may be an aggregated measurement of performance for all keywords in the keyword bid set. Such aggregated measurement may be performed according to any of a number of mathematical or statistical techniques known in the art, such as by calculating the sum, count, mean, median, mode, or any other function performed on one or more pieces of performance data. For example, in some embodiments the average CPC of all keywords in the keyword bid set may be determined. In other embodiments, the total number of clicks may be determined In still other embodiments, the number of keywords for which bids have been placed may be determined.

In some embodiments, the group performance metric may relate to the bid amount. For example, the average or total bid amount for all keywords in the keyword bid set may be determined. This may be desirable where the marketer wishes to track or cap the amount it spends on advertising.

In act 565, at least one keyword bid in the current keyword bid set is adjusted responsive to the predicted group performance metric, thereby creating an adjusted keyword bid set. In some embodiments, at least one keyword bid may be adjusted to bring the predicted group performance metric in line with a target performance metric. For example, if the total amount to be bid in the keyword bid set exceeds a certain predefined threshold spending limit represented by the target performance metric, then the bid amount for certain keywords may be reduced. In some embodiments, the target performance metric may be received from a user, for example, through a user interface. The user may enter the target performance metric as a numerical text value, or may select the target performance metric from a list of predefined values. In still other embodiments, the user may select the target performance metric by interacting with a graphical representation such as a line graph or image.

In other embodiments, the target performance metric may be received from another source through an API or by accessing a database or configuration file. In still other embodiments, the target performance metric may be calculated from historical or other data. For example, in an embodiment where the group performance metric relates to the total number of clicks during a particular time period, the bid amount for one or more keywords may be adjusted to yield a total number of clicks for the bidding group that is within limits corresponding to a total number of clicks that occurred during a previous time period.

Keyword bids may be selected for adjustment in act 565 using any of a number of techniques. In some embodiments, bid amounts for individual keywords may successively be adjusted iteratively. Bids for keywords satisfying certain conditions may be adjusted first, and other keyword bids adjusted later, until the predicted group performance metric is acceptable. In other embodiments, the keyword bid set may be adjusted via stochastic optimization. For example, keywords may be selected at random from the keyword group and their bids adjusted by some incremental amount. In other embodiments, each bid itself may be adjusted by a random amount within a defined range.

In act 570, a group performance metric for the adjusted keyword bid set is predicted in a similar manner as that described above with respect to act 550.

In act 575, the performance metric for the adjusted keyword bid set is compared to the performance metric for the current keyword bid set. In some embodiments, the comparison may be a relative comparison of numerical values. In other embodiments, the comparison may take into account other numerical or non-numerical factors. The comparison may determine which of the bid sets has a performance metric closest to a defined target value, or may determine which of the bid sets has a higher (or lower) performance metric.

In the event that the comparison determines that the adjusted keyword bid set is preferable to the current keyword bid set, the adjusted keyword bid set is selected in act 580. With reference still to FIG. 5B, the adjusted keyword bid set becomes the current keyword bid set, the method returns to act 565 as described above.

In the event that the comparison determines that the adjusted keyword bid set is not preferable to the current keyword bid set, the current keyword bid set is selected in act 590. In that case, the current keyword bid set remains (i.e., the adjusted keyword bid set is discarded), and in act 585 it is determined whether it is likely or possible that the current keyword bid set can be optimized further. If so, the method returns to act 565 as described above. If it is determined that the current keyword bid set cannot be further optimized, then the optimization effort is discontinued. Determining whether further optimization is likely or possible may include determining whether any of a defined number of recent attempts to optimize the current keyword bid set was successful. Other techniques for optimizing the current keyword bid set may be employed, including greedy algorithms such as simple and stochastic hill climbing, or algorithms employing decision trees, neural networks, or genetic algorithms.

### User Interfaces

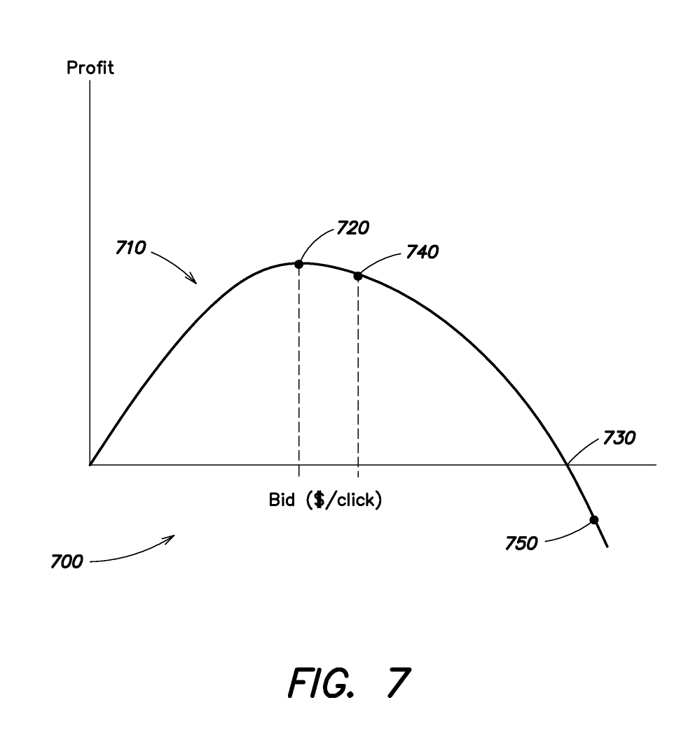

FIG. 8 shows an exemplary user interface 800 for use in connection with generating a keyword bid set. The user interface 800 may allow the user to view and adjust individual keyword bid amounts and, in response, see how the change in bid amount affects one or more performance metrics for the keyword. In particular, the user interface 800 may incorporate a Cartesian graph as are known in the art, and may graphically represent the relationship between bid amount and performance metric as a curve 840, or as any other line, curve, or other visual representation of the underlying mathematical function describing the relationship.

In some embodiments, a performance axis 810 is provided. The performance axis 810 may represent a Cartesian axis corresponding to one or more performance metrics. In some embodiments, the one or more performance metrics may be expressed as a dependent variable that depends on bid amount, which may be represented as a bid axis 820, another Cartesian axis.

In several embodiments, the user interface 800 may incorporate a metric selector 830 to allow a user to selectively associate one of a number of performance metrics with the performance axis 810. For example, the metric selector 830 may be an input element known in the art, such as a pull-down menu, combo box, text box, or radio button. The metric selector 830 may allow the user to choose a desired performance metric from a list, for example, profit, ROI, CPA, return on ad spend, total cost of conversion, impressions, clicks, or other metric. When the user selects a particular performance metric, the scale associated with the performance axis 810 may be adjusted accordingly, and the curve 840 (including its shape) may be updated to reflect the appropriate values for the corresponding bid amounts. For example, as can be seen in FIG. 8, the metric selector 830 is currently set to “Profit”, and the curve 840 represents the profit value for each of a number of bid amounts.

In some embodiments, bid amounts of possible interest may be brought to the attention of the user with one or more indicators appearing along the curve 840. An indicator may be any identifier of a particular point or range along the curve 840, such as a dot, circle, icon, or other visually distinctive object within the user interface 840. For example, as can be seen in FIG. 8, an indicator 842 corresponding to an optimal bid that will yield the maximum profit may be indicated along the curve 840. Similarly, an indicator 844 corresponding to a “super-optimal” bid amount that is a defined amount greater than the point at indicator 842 may be indicated along the curve 840. An indicator 846 corresponding to a bid amount yielding zero profit may be indicated along curve 840. The indicator may indicate a range as well as a point. For example, an indicator 848 corresponding to a range of bids yielding an allowable negative profit amount may also be indicated along curve 840.

In some embodiments, the user interface 800 may be configured to allow the system or the user to define criteria for points or ranges over which indicators should appear. For example, indicator 848 discussed above may be defined as a bid amount yielding a profit less than zero and greater than a minimum allowable negative profit. Similarly, indicator 842 discussed above may be defined to appear at the maximum point on the curve 840.

In some embodiments, a selector 850 may be provided. The selector 850 may allow the user to select a point or range of points along the curve 840 corresponding to a particular bid amount. For example, as can be seen in FIG. 8, the point selector 850 is centered over indicator 842 corresponding to a bid amount yielding maximum profit.

In some embodiments, the user interface 800 may be configured to allow an administrator to restrict selections the user makes with the selector 850 to particular points or ranges. In some embodiments, the user may be restricted to selecting only points or ranges identified by indicators as discussed previously. In other embodiments, certain portions of the curve 840 may be disabled such that the corresponding bid amounts cannot be selected by the user. For example, disabled portions 840′ of curve 840 may indicate that they cannot be selected by appearing “grayed out” or using other visual indicators known in the art.

In some embodiments, the user interface 800 may be provided with value indicators 870 and 880 in order to display the bid amount and performance metric corresponding to a particular point on the curve 840. For example, the value indicators 870 and 880 may display the bid amount and performance metric, respectively, corresponding to a point on the curve closest to where the selector of an input device (e.g., a mouse) is currently positioned. In some embodiments, the value indicators 870 and 880 may be fixed to correspond to a currently-selected point on the curve 840 until the point is deselected or a new point is selected.

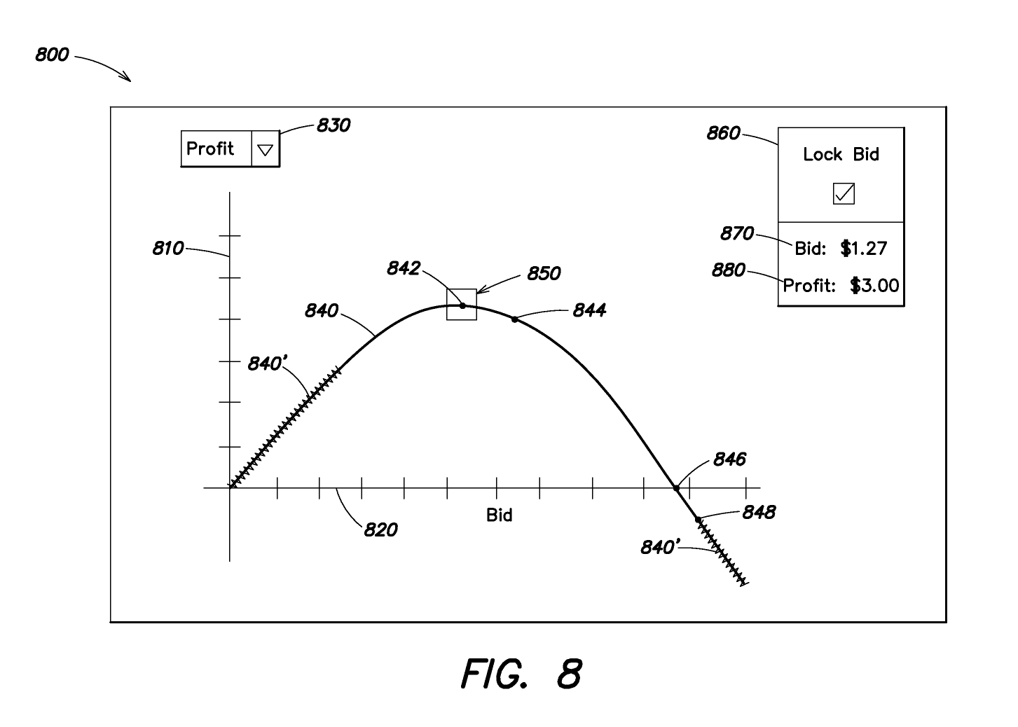

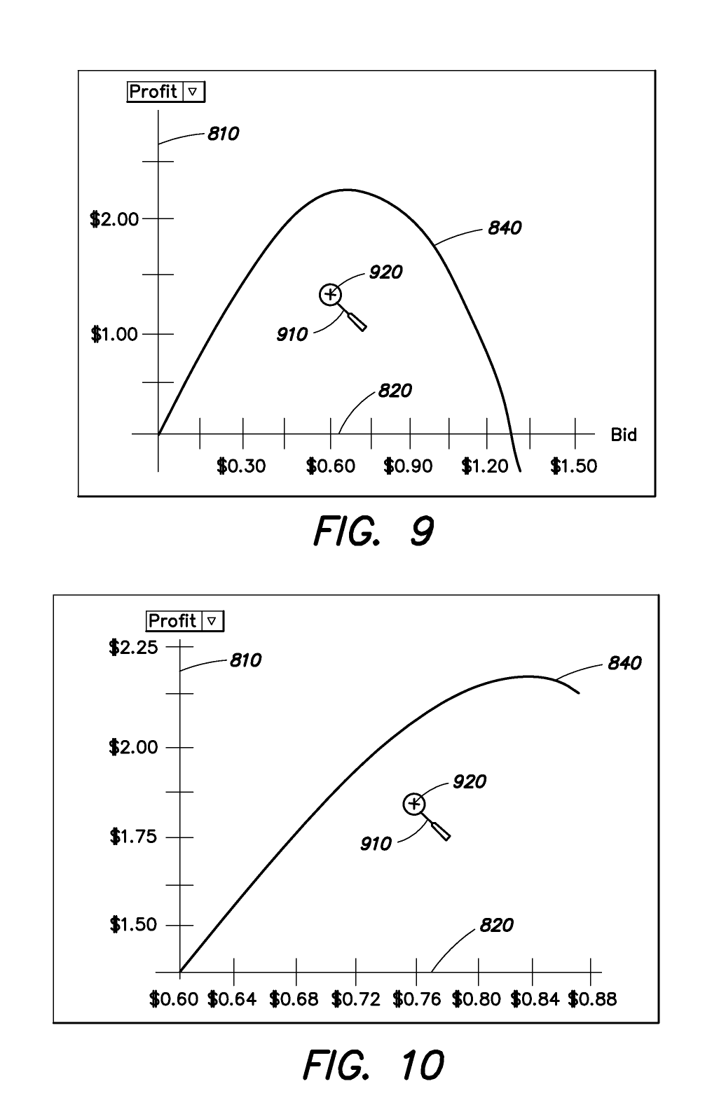

With reference to FIG. 9, in some embodiments, zoom functionality may be provided in response to a user interacting with a zoom icon 910. For example, the zoom icon 910, when centered over a zoom center 920 of the user interface 800 and activated, may enlarge a portion of the user interface 800 and/or the curve 840 around that portion. For example, as seen in FIG. 9, the zoom icon 910 may be placed over a zoom center 920 of the user interface 800 and activated. As a result, the area around the zoom center 920 is enlarged, as can be seen in FIG. 10. The scale of the performance axis 810 and the bid axis 820 are adjusted and the curve 840 is redrawn accordingly.

Returning again to FIG. 8, lock selector 860 may be provided to allow the user of the user interface 800 to “lock” the currently-selected bid price to prevent that keyword from being adjusted during the act of adjusting, responsive to the predicted group performance metric, at least one keyword bid in the keyword bid set.

The user interface 800 is provided for exemplary purposes, and different configurations of data may be displayed and different statistical methods may be performed in other embodiments. Further, some or all of the interfaces may be incorporated into a software suite or package.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A method for generating at least one keyword bid comprising:
accessing, over a computer network, marketing keyword data including bid data, advertising spend data, and revenue data;
estimating a first relationship between the revenue data and the bid data;
estimating a second relationship between the advertising spend data and the bid data; and
generating at least one keyword bid based at least in part on the first relationship and the second relationship.

2. The method of claim 1, wherein the act of accessing, over a computer network, marketing keyword data further comprises an act of accessing cost-of-goods-sold data, further comprising an act of estimating a third relationship between the cost-of-goods-sold data and the bid data, wherein the act of generating at least one keyword bid based at least in part on the first relationship and the second relationship comprises an act of generating at least one keyword bid based at least in part on the first relationship, the second relationship, and the third relationship.

3. The method of claim 2, wherein the act of generating at least one keyword bid based at least in part on the first relationship, the second relationship, and the third relationship further comprises an act of identifying a keyword bid yielding a maximal profit.

4. The method of claim 2, wherein the act of generating at least one keyword bid based at least in part on the first relationship, the second relationship, and the third relationship comprises an act of identifying a keyword bid yielding a less-than-maximal profit.

5. The method of claim 4, wherein the act of generating at least one keyword bid based at least in part on the first relationship, the second relationship, and the third relationship further comprises an act of identifying a keyword bid yielding a profit substantially equal to zero.

6. The method of claim 4, wherein the act of generating at least one keyword bid based at least in part on the first relationship, the second relationship, and the third relationship further comprises an act of identifying a keyword bid yielding an allowably negative profit.

7. The method of claim 2, wherein the act of generating at least one keyword bid based at least in part on the first relationship, the second relationship, and the third relationship further comprises an act of identifying a keyword bid yielding a maximum number of clicks.

8. The method of claim 2, wherein the act of accessing, over a computer network, marketing keyword data includes accessing an impression count.

9. The method of claim 8, wherein the act of generating at least one keyword bid based at least in part on the first relationship, the second relationship, and the third relationship further comprises an act of identifying a keyword bid yielding a maximum number of impressions.

10. The method of claim 2, wherein the act of accessing, over a computer network, marketing keyword data further comprises an act of accessing budget limit data representing an advertising budget.

11. The method of claim 10, wherein the act of generating at least one keyword bid based at least in part on the first relationship, the second relationship, and the third relationship includes comparing the budget limit data to the advertising spend data.

12. The method of claim 11, wherein the act of generating at least one keyword bid based at least in part on the first relationship, the second relationship, and the third relationship further comprises an act of identifying a keyword bid having a highest profit.

13. The method of claim 12, further comprising an act of allocating a portion of a budget to the specific keyword bid.

14. The method of claim 13, further comprising an act of iteratively allocating portions of a budget to each of the at least one keyword bid in descending order of marginal profit.

15. The method of claim 14, further comprising an act of ceasing allocating portions of the budget when the entire budget is allocated.

16. The method of claim 1, wherein the act of generating at least one keyword bid based at least in part on the first relationship and the second relationship further comprises an act of identifying a keyword bid yielding a maximal return on advertising spend.

17. The method of claim 1, wherein the act of generating at least one keyword bid based at least in part on the first relationship and the second relationship further comprises an act of identifying a keyword bid yielding a return on advertising spend substantially equal to zero.

18. The method of claim 1, wherein the act of generating at least one keyword bid based at least in part on the first relationship and the second relationship further comprises an act of is identifying a keyword bid yielding an allowably negative return on advertising spend.

19. The method of claim 1, wherein the act of accessing, over a computer network, marketing keyword data further comprises an act of accessing budget limit data representing an advertising budget.

20. The method of claim 19, wherein the act of generating at least one keyword bid based at least in part on the first relationship and the second relationship further comprises an act of identifying a keyword bid having a highest return on advertising spend.

21. The method of claim 20, further comprising an act of allocating a portion of the advertising budget to the at least one keyword bid having the highest return on advertising spend.

22. The method of claim 21, further comprising an act of iteratively allocating portions of the advertising budget to each of the at least one keyword bids in descending order of marginal return on advertising spend.

23. The method of claim 22, further comprising an act of ceasing allocating portions of the advertising budget when the entire budget is allocated.

24. The method of claim 1, further comprising an act of transmitting the at least one keyword bid to an advertising network via the computer network.

25. A method for generating at least one keyword bid comprising:
accessing, over a computer network, marketing keyword data including at least bid data, advertising spend data, and conversion data;
estimating a first relationship between the advertising spend data and the bid data;
estimating a second relationship between the conversion data and the bid data; and
generating at least one keyword bid based at least in part on the first relationship and the second relationship.

26. The method of claim 25, wherein the act of accessing, over a computer network, marketing keyword data further comprises an act of accessing a target value per conversion.

27. The method of claim 26, wherein the act of generating at least one keyword bid based at least in part on the first relationship and the second relationship further comprises an act of identifying a keyword bid yielding a maximal number of conversions based at least in part on the target value per conversion.

28. The method of claim 26, wherein the act of generating at least one keyword bid based at least in part on the first relationship and the second relationship further comprises an act of identifying a keyword bid yielding a maximal number of clicks based at least in part on the target value per conversion.

29. The method of claim 26, wherein the act of accessing, over a computer network, marketing keyword data further comprises an act of accessing impression data.

30. The method of claim 29, wherein the act of generating at least one keyword bid based at least in part on the first relationship and the second relationship further comprises an act of identifying a keyword bid yielding a maximal number of impressions, based at least in part on the target value per conversion and the impression data.

31. The method of claim 25, wherein the act of accessing, over a computer network, marketing keyword data further comprises an act of accessing budget limit data.

32. The method of claim 31, wherein the act of generating at least one keyword bid based at least in part on the first relationship and the second relationship further comprises an act of identifying a keyword bid yielding a maximal number of conversions, based at least in part on the budget limit data.

33. The method of claim 31, wherein the act of generating at least one keyword bid based at least in part on the first relationship and the second relationship further comprises an act of identifying a keyword bid yielding a maximal number of clicks, based at least in part on the budget limit data.

34. The method of claim 31, wherein the act of accessing, over a computer network, marketing keyword data further comprises an act of accessing impression data.

35. The method of claim 34, wherein the act of generating at least one keyword bid based at least in part on the first relationship and the second relationship further comprises an act of identifying a keyword bid yielding a maximal number of impressions, based at least in part on the budget limit data and the impression data.

36. The method of claim 31, further comprising an act of identifying a keyword bid with the lowest marginal cost per conversion.

37. The method of claim 36, further comprising an act of allocating a portion of the advertising budget to the specific keyword bid.

38. The method of claim 37, further comprising an act of iteratively allocating portions of the advertising budget to each of the at least one keyword bids in ascending order of marginal cost per conversion.

39. The method of claim 38, further comprises an act of ceasing allocating portions of the advertising budget when the entire budget is allocated.

40. A method for generating at least one keyword bid comprising:
accessing, over a computer network, marketing keyword data including at least bid data, advertising spend data, and click data;
estimating a first relationship between the advertising spend data and the bid data;
estimating a second relationship between the click data and the bid data; and
generating at least one keyword bid based at least in part on the first relationship and the second relationship.

41. A method for generating at least one keyword bid comprising:
accessing, over a computer network, marketing keyword data including at least bid data, advertising spend data, and impression data;
estimating a first relationship between the advertising spend data and the bid data;
estimating a second relationship between the impression data and the bid data; and
generating at least one keyword bid based at least in part on the first relationship and the second relationship.

42. A system comprising:
a memory configured to store bid data, advertising spend data, revenue data, and cost-of-goods-sold data;
a relationship engine configured to estimate a first relationship between the revenue data and the bid data, a second relationship between the advertising spend data and the bid data, and a third relationship between the cost-of-goods-sold data and the bid data; and
a bid generation engine configured to generate at least one keyword bid based at least in part on the first relationship, the second relationship, and the third relationship.

43. The system of claim 42, wherein the bid generation engine further comprises an adjustment engine configured to adjust, responsive to the user input, at least one keyword bid, further comprising a user interface configured to receive user input.

44. The system of claim 43, wherein the user interface further comprises a performance axis of a cartesian graph, and wherein the system is configured to receive user input and, responsive to the user input, selectively associate the performance axis with a performance metric.

45. The system of claim 44, wherein the user interface further comprises a performance curve based at least in part on the first relationship, the second relationship, and the third relationship.

46. The system of claim 45, wherein a first portion of the performance curve corresponding to disallowed bid amounts is disabled, and wherein a second portion of the performance curve corresponding to allowed bid amounts is enabled.

47. The system of claim 42, further comprising a network interface configured to allow the system to access, over a computer network, the bid data, the advertising spend data, the revenue data, and the cost-of-goods-sold data.

48. The system of claim 42, further comprising an application programming interface configured to access the bid data, the advertising spend data, the revenue data, and the cost-of-goods-sold data on a second system.

49. The system of claim 48, wherein the second system comprises a database associated with a search engine.

50. A computer-readable medium comprising computer-executable instructions that, when executed on a processor of a server, perform a method for generating at least one keyword bid, comprising acts of:
A method for generating at least one keyword bid comprising:
accessing, over a computer network, marketing keyword data including bid data, advertising spend data, revenue data, and cost-of-goods-sold data;
estimating a first relationship between the revenue data and the bid data;
estimating a second relationship between the advertising spend data and the bid data;
estimating a third relationship between the cost-of-goods-sold data and the bid data; and
generating at least one keyword bid based at least in part on the first relationship, the second relationship, and the third relationship.
